(19) United States
(12) Patent Application Publication
(10) Pub. No.: US 2009/0039553 A1
(43) Pub. Date: Feb. 12, 2009

(54) MICROSTRUCTURED SURFACE MOLDING METHOD

(75) Inventor: Thomas R. Corrigan, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/836,854

(22) Filed: Aug. 10, 2007

(51) Int. Cl. C03B 23/02

(52) U.S. Cl. 264/293; 29/592.1

(57) ABSTRACT

This disclosure relates to methods and apparatus for forming a plurality of microstructured sets of cells on a substrate, wherein each set of cells may be formed from a discrete flexible mold. Each mold is independently adjustable in position relative to the substrate. Side-by-side independently adjustable molds are pressed against the substrate by a single lamination roller.

### BACKGROUND

Advancements in display technology, including the development of plasma display panels (PDPs) and plasma addressed liquid crystal (PALC) displays, have led to an interest in forming electrically-insulating ceramic barrier ribs on glass substrates. The ceramic barrier ribs separate cells in which an inert gas can be excited by an electric field applied between opposing electrodes. The gas discharge emits ultraviolet (UV) radiation within the cell. In the case of PDPs, the interior of the cell is coated with a phosphor that gives off red, green, or blue visible light when excited by UV radiation. The size of the cells determines the size of the picture elements (pixels) in the display. PDPs and PALC displays can be used, for example, as the displays for high definition televisions (HDTV) or other digital electronic display devices.

One way in which ceramic barrier ribs can be formed on glass substrates is by direct molding. This has involved laminating a planar rigid mold onto a substrate with a glass- or ceramic-forming composition disposed therebetween. The glass- or ceramic-forming composition is then solidified and the mold is removed. Finally, the barrier ribs are fused or sintered by firing at a temperature of about 550° C. to about 1600° C. The glass- or ceramic-forming composition has micrometer-sized particles of glass frit dispersed in an organic binder. The use of an organic binder allows barrier ribs to be solidified in a green state so that firing fuses the glass particles in position on the substrate.

The mold for producing the barrier ribs and thus the cells of glass substrates may also be a flexible mold. A method has been disclosed of making a microstructured article having at least two such discrete molds. The method employs applying a curable composition to the substrate and transferring each independently positionable mold such that microstructured surface of the mold contacts the curable composition and a pattern on the substrate is aligned with the microstructured surface of the mold. The molds are transferred by a transfer drum.

### SUMMARY

In one aspect, the disclosure sets forth a method for forming a plurality of discrete sets of cells on a substrate used for forming plasma display panels. The method comprises locating baseline fiducials relative to a substrate support surface and disposing a first portion of each of a plurality of mold sheets over the substrate support surface. The first portion of each mold sheet has a microstructured surface facing the substrate support surface that defines a mold comprising, at least in part, a reverse image of a set of cells thereon, and the first portion of each mold sheet has fiducials thereon. The method further comprises comparing the relative positions of fiducials on each mold sheet with the baseline fiducials, and securing a second portion of each mold sheet to an adjustment mount relative to the substrate support surface to bring the fiducials of each mold sheet into a first desired spatial relationship with the baseline fiducials, thereby adjusting the position of the first portion of each mold sheet independently relative to the substrate support surface.

In another aspect, the disclosure sets forth a method for forming a plurality of discrete sets of cells on substrates used for plasma display panels, wherein the method comprises advancing a first substrate of a plurality of substrates onto a table, wherein at least a portion of each substrate is coated with cell formation paste. The method further comprises disposing a plurality of side-by-side flexible mold sheets over the paste on the surface of each substrate when that substrate is on the table, wherein each mold sheet has a microstructured surface facing the paste on the surface of said substrate that defines a mold comprising, at least in part, a reverse image of a set of cells thereon. The method further comprises adjusting the position of each mold sheet independently relative to the first substrate, fixing the position of each mold sheet independently relative to the first substrate, pressing the mold sheets against the first substrate to form in the paste on the first substrate for each mold sheet, a positive image of the mold defined by the microstructure surface of that mold sheet, disengaging each mold sheet from the first substrate, replacing the first substrate on the table with a second substrate advanced onto the table, wherein at least a portion of an exposed portion of the second substrate is coated with cell formation paste, and optionally adjusting the position of each mold sheet independently relative to the second substrate. The method further comprises fixing the position of each mold sheet independently relative to the second substrate, and pressing the mold sheets against the second substrate to form in the paste on the second substrate, for each mold sheet, a positive image of the mold defined by the microstructured surface of that mold sheet.

This summary is provided to introduce a selection of concepts in a simplified form that are further described below in the detailed description. This summary is not intended to identify key features or essential features of the claimed subject matter, is not intended to describe each disclosed embodiment or every implementation of the claimed subject matter, and is not intended to be used as an aid in determining the scope of the claimed subject matter. Many other novel advantages, features, and relationships will become apparent as this description proceeds. The figures and the description that follow more particularly exemplify illustrative embodiments. It should be noted that the figures have not been drawn to scale as it has been necessary to modify certain portions for clarity.

### BRIEF DESCRIPTION OF THE DRAWINGS

The disclosed subject matter will be further explained with reference to the attached figures, wherein like structure is referred to by like reference numerals throughout the several views.

FIG. 1 is a schematic representation of an illustrative plasma display panel.

FIG. 2 is an isometric schematic illustration of a molding assembly.

FIG. 3 is a schematic side elevation of the molding assembly of FIG. 2.

FIG. 4 is a schematic top view of the molding assembly of FIG. 2, with a vision system and a curing system of the molding assembly removed for clarity of illustration.

FIG. 5 is an enlarged sectional view of a portion of the molding assembly of FIG. 4, as taken along lines 5-5 in FIG. 4.

FIG. 6 is an end view of a portion of the molding assembly of FIG. 3, as taken generally along lines 6-6 in FIG. 3.

FIGS. 7-20 are schematic illustrations showing various stages and configurations of one embodiment of the molding assembly of the present disclosure.

FIG. 21 is a schematic top view of a portion of an alternative embodiment of a molding assembly.

FIG. 22-24 are schematic illustrations showing various stages and configurations of the embodiment of FIGS. 7-20, illustrating a mold sheet replacement sequence.

While the above-identified figures set forth one or more embodiments of the disclosed subject matter, other embodiments are also contemplated, as noted in the disclosure. In all cases, this disclosure presents the disclosed subject matter by way of representation and not limitation. It should be understood that numerous other modifications and embodiments can be devised by those skilled in the art which fall within the scope and spirit of the principles of this disclosure.

### DETAILED DESCRIPTION

The present disclosure is believed to be applicable to methods of making microstructures on a substrate using a mold, as well as the articles and devices made using the methods. In particular, the present disclosure is directed to making ceramic microstructures on a substrate using a mold. Plasma display panels (PDPs) can be formed using the methods and provide a useful illustration of the methods.

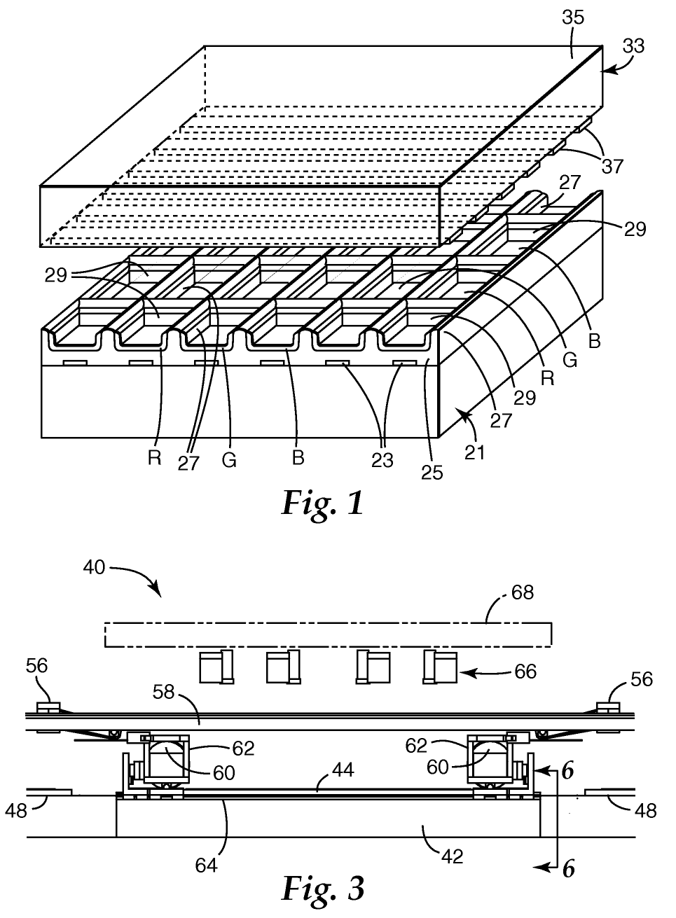

Plasma display panels (PDPs) have various components, as illustrated in FIG. 1. A back substrate 21, oriented away from the viewer, has a pattern of independently addressable parallel electrodes 23. The back substrate 21 can be formed from a variety of compositions, for example, glass. Ceramic microstructures 25 are formed on the back substrate 21 and include barrier rib portions 27 that extend in one direction between electrodes 23 and barrier rib portions 29 that extend across electrodes 23. The rib portions 27 and 29 combine to form cells 31 in which red (R), green (G), and blue (B) phosphors are deposited. A front substrate 33 includes a glass substrate 35 and a set of independently addressable parallel electrodes 37. These front electrodes 37, also called sustain electrodes, are oriented perpendicular to the back electrodes 23, also referred to as address electrodes. In a completed display, the area between the front and back substrate elements is filled with an inert gas. To light up a pixel, an electric field is applied between crossed sustain 37 and address electrodes 23 with enough strength to excite the inert gas atoms therebetween. The excited inert gas atoms emit ultraviolet (UV) radiation that causes the phosphor to emit red, green, or blue visible light.

Back substrate 21 is preferably a transparent glass substrate. Typically, for PDP applications back substrate 21 is made of soda lime glass that is optionally substantially free of alkali metals. The temperatures reached during processing can cause migration of the electrode material in the presence of alkali metal in the substrate. This migration can result in conductive pathways between electrodes, thereby shorting out adjacent electrodes or causing undesirable electrical interference between electrodes known as “crosstalk.” Front substrate 33 is typically a transparent glass substrate which preferably has the same or about the same coefficient of thermal expansion as that of the back substrate 21.

Electrodes 23, 37 are strips of conductive material. The electrodes 23 are formed of a conductive material such as, for example, copper, aluminum, or a silver-containing conductive frit. The electrodes can also be a transparent conductive material, such as indium tin oxide, especially in cases where it is desirable to have a transparent display panel. The electrodes are patterned on back substrate 21 and front substrate 35. For example, the electrodes can be formed as parallel strips spaced about 120 μm to 360 μm apart, having widths of about 50 μm to 75 μm, thicknesses of about 2 μm to 15 μm, and lengths that span the entire active display area which can range from a few centimeters to several tens of centimeters. In some instances the widths of the electrodes 23, 37 can be narrower than 50 μm or wider than 75 μm, depending on the architecture of the microstructures 25.

The height, pitch and width of the microstructured barrier ribs portions 27 and 29 in PDPs can vary depending on the desired finished article. The pitch (number per unit length) of the barrier ribs 27 preferably matches the pitch of the electrodes. The height of the barrier ribs is generally at least 100 μm and typically at least 150 μm. Further, the height is typically no greater than 500 μm and typically less than 300 μm. The pitch of the barrier rib pattern may be different in the longitudinal direction in comparison to the transverse direction. The pitch is generally at least 100 μm and typically at least 200 μm. The pitch is typically no greater than 600 μm and typically less than 400 μm. The width of the barrier rib pattern may be different between the upper surface and the lower surface, particularly when the barrier ribs thus formed are tapered. The width is generally at least 10 μm, and typically at least 50 μm. Further, the width is generally no greater than 100 μm and typically less than 80 μm.

When using the methods of the present disclosure to make microstructures on a substrate (such as barrier ribs for cells for a PDP), the coating material from which the microstructures are formed is a slurry or paste containing a mixture of at least three components. The first component is a glass or ceramic forming particulate inorganic material (typically, a ceramic powder.) Generally, the inorganic material of the slurry or paste is ultimately fused or sintered by firing to form microstructures having desired physical properties adhered to the patterned substrate. The second component is a binder (e.g., a fugitive binder) that is capable of being shaped and subsequently hardened by curing or cooling. The binder allows the slurry or paste to be shaped into semi-rigid green state microstructures that are adhered to the substrate. The third component is a diluent that can promote release from the mold after alignment and hardening of the binder material, and can promote fast and complete burn out of the binder during debinding before firing the ceramic material of the microstructures. The diluent preferably remains a liquid after the binder is hardened so that the diluent phase-separates from the binder during binder hardening.

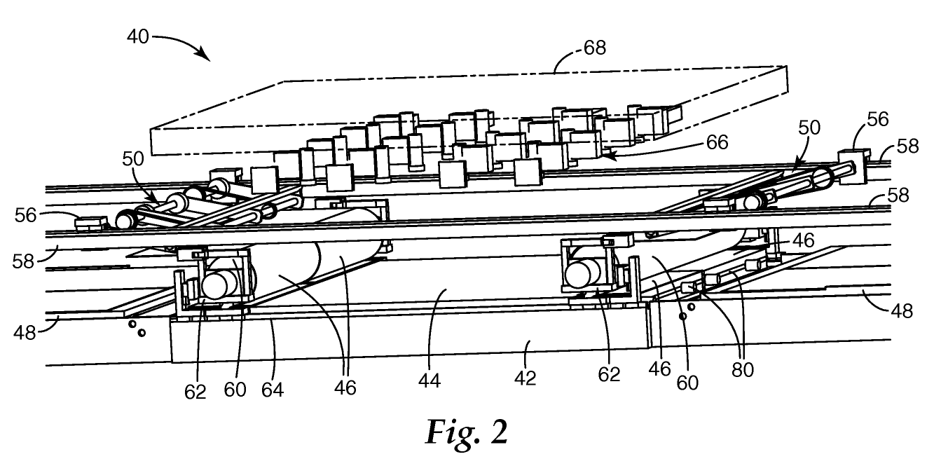

A molding apparatus is employed to position the substrate bearing the coating material on one side thereof with a plurality of independently positionable flexible mold sheets. An exemplary coating apparatus for this purpose is illustrated in FIGS. 2-4. The substrate is supported on a substrate support surface, and by the use of respective fiducials on the substrate and substrate support surface is aligned therewith. Each flexible mold sheet is likewise aligned relative to fiducials of the substrate support surface and fiducials on that mold sheet. Each mold sheet is independently aligned and then fixed in place for contact with the coating material. A laminating roller then urges two or more mold sheets against the coating material on the substrate at the same time. After curing of the coating material, each mold sheet is then separated from the cured coating material and the substrate removed from the substrate support surface. This cycle may be repeated, with each mold sheet being realigned relative to substrate as necessary to achieve the desired relationship between molded cells and electrodes on the substrate.

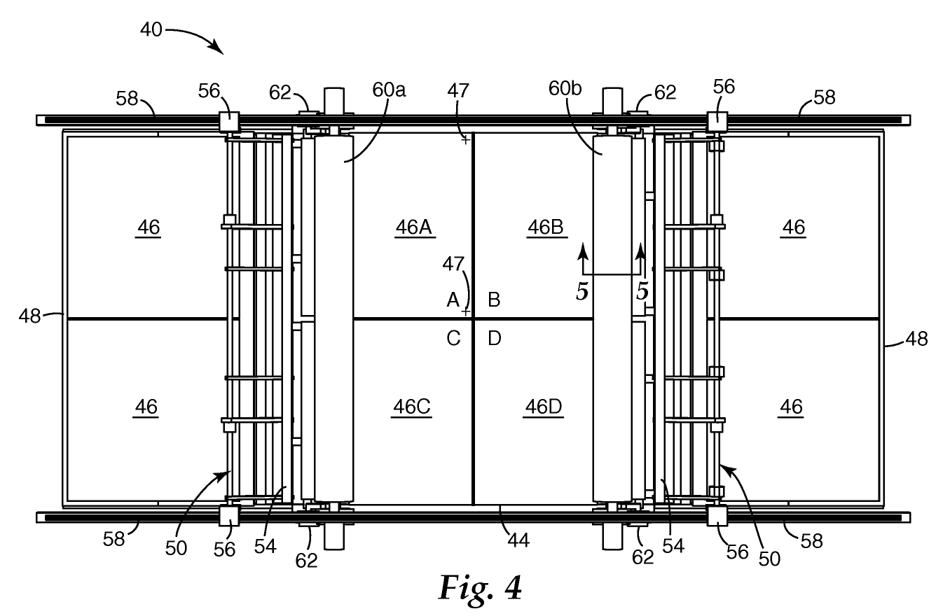

This molding process may be accomplished using the illustrative molding apparatus 40 illustrated in FIGS. 2-4. Molding apparatus 40 includes a substrate support surface or table 42 that has a planar upper surface for receiving a substrate 44 thereon (substrate 44 can correspond to the back substrate 21 in FIG. 1). At some point prior to contacting the substrate with the mold (either before disposed on the table 42 or after), coating material is disposed on a top surface of the substrate 44. The coating material may cover the entire substrate 44, or may be disposed in discrete sections (with each section corresponding to the formation of a desired discrete plasma display panel). In other words, a single substrate is used to form portions of a plurality of plasma display panels at the same time. In the embodiment illustrated in FIGS. 2-4, the substrate has four sections thereon which will be ultimately used to form portions of four plasma display panels (see sections A, B, C and D in FIG. 4, wherein each section has an electrode pattern thereon). In this arrangement, four flexible mold sheets 46 are provided, one for each section of the substrate 44. Thus, in the illustrated embodiment, there is a first set of mold sheets 46A and 46C associated with a first lamination roller 60a and a second set of mold sheets 46B and 46D associated with a second lamination roller 60b. Each mold sheet 46 has a first portion that has a microstructured surface thereon. The microstructured surface faces the substrate support surface and defines a mold that comprises, at least in part, a reverse image of a set of cells thereon. The cells may be such as those as exemplified in FIG. 1 between barrier ribs 27 and 29, or they may have other configurations and/or arrangements. For example, the cells may be in staggered rows like in a brick-like formation, some cells may be larger than others, or the cells may have shapes other than rectangular. In addition, each set of cells may be a random or non-random dispersal of cells, or include random or non-random cell sections thereon.

Mold sheets 46 are provided for use in the molding apparatus 40 from mold sheet staging areas 48, where a plurality of mold sheets 46 are stacked. Each mold sheet 46 is transferred from its respective mold sheet staging area 48 to a position of use in the molding apparatus 40 by a mold sheet transfer apparatus 50. In one embodiment, each mold sheet transfer apparatus 50 includes a mold sheet engagement bar 54 (see FIG. 4) adapted for gripping a portion of each mold sheet 46 (either via a vacuum plate or other suitable gripping means) to move the mold sheet 46 through the molding apparatus 40. The mold sheets 46 are stacked in the mold sheet staging areas 48 facedown (i.e., each mold sheet having its mold-bearing surface facing downwardly) so that the gripping bar 54 engages a back surface of each mold sheet 46 for manipulation thereof. Each gripping bar 54 is in turn connected to a movement assembly 56 which can move (for example along rails 58) to advance the mold sheet 46 toward and away from the table 42. The movement assembly 56 is also operable to raise and lower the engagement bar 54, thereby raising and lowering a mold sheet 46 attached thereto relative to the table 42. In addition, the movement assembly 56 can also control the orientation of the engagement bar 54 (e.g., rotation thereof about an axis extending laterally across the table).

For at least each pair of adjacent mold sheets 46, a single lamination roller 60 is provided. The lamination roller 60 can be raised to allow the insertion of mold sheet portions thereunder. In its lowered configuration, the lamination roller 60 is used to urge each mold sheet 46 toward the table 42 and against the paste on a substrate 44 supported on the table 42, wherein the paste is at least disposed over the electrode pattern on each section of the substrate. The pressing of the mold on each mold sheet 46 against the paste on the substrate 44 thus forms, in the paste on the substrate 44, a positive image of the mold defined by the microstructured surface of that mold sheet 46. Each lamination roller 60 is supported by a suitable roller bearing and movement assembly 62 at its ends, which in turn may be supported on rails 64 to allow movement of the laminating rollers across the table 42.

A vision system 66 is disposed above the table 42 for use in alignment of the substrate 44 and mold sheets 46 relative to the table 42 (and relative to each other). The vision system 66 may include one or more cameras or sensors for use in alignment of components on or relative to the table 42. The vision system 66 may be fixed in position over the table 42, or it may be moveable in and out of position thereover. The vision system 66 locates and compares the relative positions of fiducials on the various components of the system disclosed herein, such as, for example, fiducials 47 on the mold sheet 46A (see FIG. 4).

A coating material curing system 68 may also be disposed over the table 42. The curing system 68 may include a bank of curing lights of proper wave length to cure the coating material, and the curing system 68 may likewise be moveable so that it may be raised or moved into or out of position over the table 42.

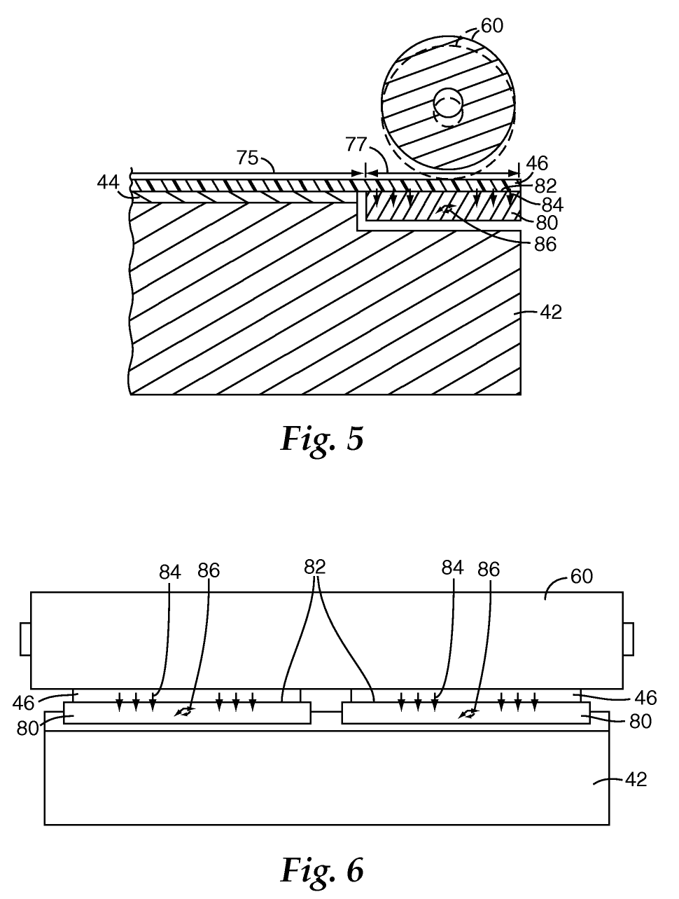

FIGS. 5 and 6 illustrate schematically how each mold sheet 46 is held in position relative to the table 42. Each mold sheet 46 has a first portion 75, which bears the microstructured surface that defines the mold for that mold sheet 46, and which corresponds generally to the portion of each mold sheet 46 that extends over its respective section A, B, C or D of the substrate 44 (see FIG. 4). Each mold sheet 46 also includes a second portion or mold sheet tail 77 which provides the means for manipulating the position of the mold sheet 46 relative to the table 42. An adjustment mount 80 is provided for each mold sheet 46 in order to support and engage the second portion 77 of each mold sheet 46. Each adjustment mount 80 has an upper surface 82 which engages a lower face of the second portion 77 of its respective mold sheet 46. In one embodiment, the upper surface 82 has a vacuum plate which, when activated, pulls the second portion 77 of the mold sheet 46 firmly against it for coupled movement therebetween, as indicated by mold sheet attachment force arrows 84 in FIGS. 5 and 6. Other means for coupling the second portion 77 of each mold sheet 46 to its respective adjustment mount 80 are contemplated, such as magnetic or mechanical grippers or clamps therebetween. Each adjustment mount 80 is supported with respect to the table 42, but is allowed to move relative to the table 42 in three degrees of motion (i.e., x, y and θ), as illustrated by orthogonal arrow sets 86 in FIGS. 5 and 6. The movement of each adjustment mount 80 relative to the table 42 is accomplished by suitable means, such as solenoids, servo drive motors, piezzo-electric actuators, hydraulics or the like. Each adjustment mount 80 may be moveable, while holding the second portion 77 of its respective mold sheet 46, with a precision of less than one micron in any axis, or an angular precision of less than 0.1 arc second.

As illustrated in FIG. 6, each adjustment mount 80 is individually moveable relative to the table 42 for use in aligning its respective mold sheet 46. However, adjacent mold sheets 46 are laminated by a single laminating roller 60 that spans adjacent adjustment mounts 80, as seen in FIG. 6.

As noted above, a vision system 66 is used to align the mold sheets 46 for use. One or more fiducials may be provided on the top surface of the table 42. A fiducial in this regard is an optically visible or detectable reference mark. Alternatively, or in addition to, a separate fiducial plate may be used to assist in calibrating the respective position of components using the vision system 66. A fiducial plate may also include one or more fiducials thereon which may be compared, using the vision system 66 with the fiducials of the table 42. The fiducial plate may be disposed on the table 42 at the intiation of the processing for calibration purposes, or may be periodically used to recalibrate the process. The fiducial plate is removed during processing, to make room for the substrate 44 on the table 42. The substrate 44 may also include one or more fiducials thereon for detection by the vision system 66. In one embodiment, those fiducials are located outside the electrode patterns on the substrate. The fiducial plate and substrates 44 are advanced on and off of the table 42 by suitable plate advancement techniques and apparatus, as is known, and their positions may be adjusted likewise by known means relative to the table 42. The fiducial plate and substrate manipulation system may be capable of positioning those components on the table 42 with a precision of +/−5 μm or less relative to fiducials of the table 42. Each mold sheet 46 also includes one or more fiducials thereon. In one embodiment, those fiducials are located outside the mold area on each mold sheet. When the mold sheets 46 are disposed over the fiducial plate or a substrate on the table 42, the fiducials on the mold sheet 46 are compared with baseline fiducials established by the fiducials of the table and fiducial plate and substrate in order to achieve the desired alignment of the mold on each mold sheet 46 with the electrodes 23 on the substrate 44. The vision system 66 may be capable of locating fiducials on fiducial plates substrates and comparing their positions with a precision of +/−1 μm or less. The lamination of each mold sheet 46 with the substrate 44 is accomplished by locating respective fiducials thereon and positioning each mold sheet 46 in response to the relative fiducial positions, using the adjustment mount 80 for each mold sheet 46.

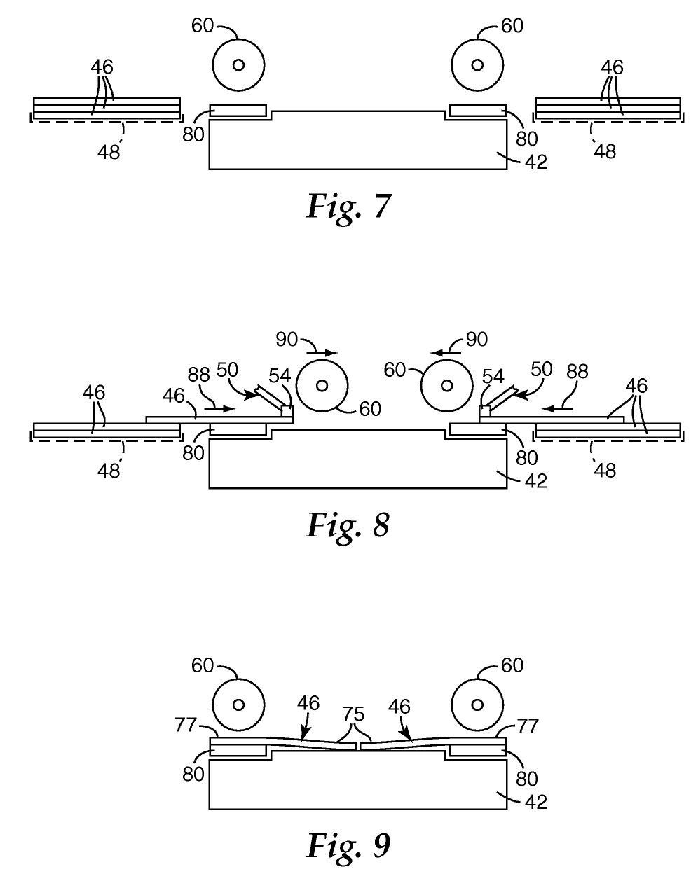

FIGS. 7-20 illustrates schematically the process of a method of forming a plurality of discrete sets of cells on a substrate used for forming plasma display panels. In FIG. 7, table 42 is shown with its associated adjustment mounts 80 at each end thereof, and their respective lamination rollers 60. Each lamination roller 60 is spaced vertically from its respective adjustment mounts 80. A plurality of mold sheets 46 are disposed in stacks at mold sheet staging areas 48 at each end of the table 42. The top mold sheet 46 of each stack is ready for next use in the molding apparatus.

FIG. 8 illustrates the loading of the top mold sheet 46 into the molding apparatus. The mold sheet transfer apparatus 50 engages that top mold sheet 46 (via mold sheet engagement bar 54) and carries it onto and above the table 42, in direction of respective arrows 88. As each mold sheet transfer apparatus 50 moves across the table 42, its respective lamination roller 60 also moves out of its way, such as in direction of respective arrows 90. The sequence of loading of the top mold sheet from each stack onto the table 42 of the molding apparatus is staggered, so as to save time and minimize interference between the opposed lamination rollers and mold sheet transfer apparatii. Once the set of mold sheets (e.g., two mold sheets, such as seen in FIG. 6) for each lamination roller is fully advanced into position over the table 42, each lamination roller 60 moves in direction opposite of its respective arrow 90 back to its original position relative to the table 42 and its respective adjustment mount 80 (as seen in FIG. 7). Likewise, once each mold sheet is positioned over the table 42, the mold sheet transfer apparatus releases the mold sheet and moves out of the way, to allow return movement of its respective lamination roller to its original position. As seen in FIG. 9 and in FIG. 5, the first portion 75 of each mold sheet 46 is thus disposed over the table 42, while the second portion 77 of each mold sheet is disposed over its respective adjustment mount 80 and below (but not yet engaged by) the lamination roller 60. This initial loading of mold sheets 46 onto the table 42 (via the mold sheet transfer apparatus) may be able to position the mold sheets 46 with an accuracy of +/−50 μm on the table 42.

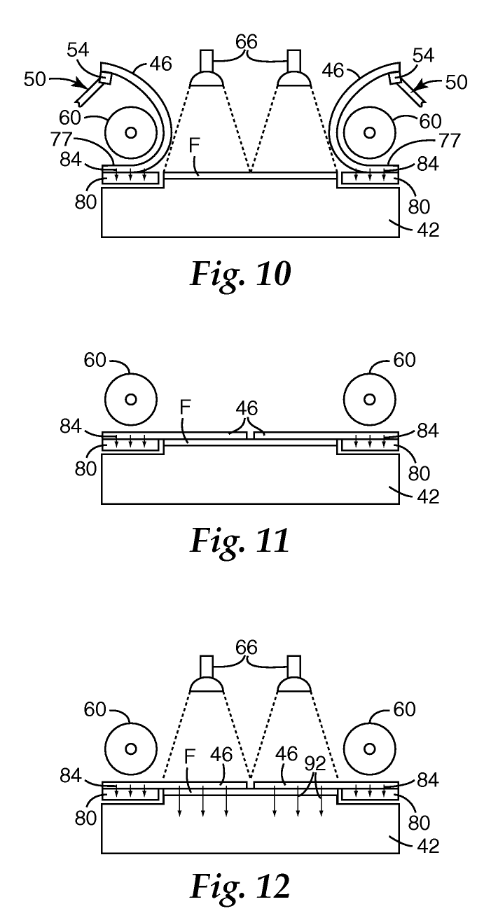

The second portion 77 of each mold sheet 46 is affixed in a position relative to its adjustment mount 80 (such as by vacuum force as indicated by arrows 84 in FIG. 10) to fix the mold sheet 46 to its adjustment mount 80. The mold sheet transfer apparatus 50 for each set of mold sheets is then advanced and engages a free end of the first portion of each mold sheet 46 via mold sheet engagement bar 54. The mold sheet transfer apparatus then moves outwardly to its end of the table 42, thereby lifting the mold sheet 46 off of the top surface of the table 42 and bending it back over its respective lamination roller 60, as seen in FIG. 10. A calibration or fiducial plate F is then loaded onto the table 42. Using the vision system 66, fiducials on the fiducial plate and the table 42 are compared to define baseline fiducials for the molding process.

As seen in FIG. 11, each mold sheet transfer apparatus 50 has been moved over the table 42 to dispose the set of mold sheets carried thereby on top of the fiducial plate F. The mold sheet engagements bars 54 release the mold sheets 46 and each mold sheet transfer apparatus 50 then moves outwardly to at least a position where it is not over the fiducials of the mold sheets 46. The second portion of each mold sheet 46 remains affixed to its respective adjustment mount (such as by a vacuum force pressure as indicated by arrows 84).

As seen in FIG. 12, the first portions of the mold sheets 46 are flattened against the fiducial plate F by suitable means, such as drawing a vacuum from the table 42 through perforations in the fiducial plate F, as indicated by vacuum force arrows 92. The top surface of the table 42 may be flat within 5 μm over a one meter distance. Once the mold sheets 46 are flattened and fixed in position via the vacuum forces 92, the vision system 66 is again activated to compare the relative positions of the fiducials on the mold sheets 46 with the baseline fiducials.

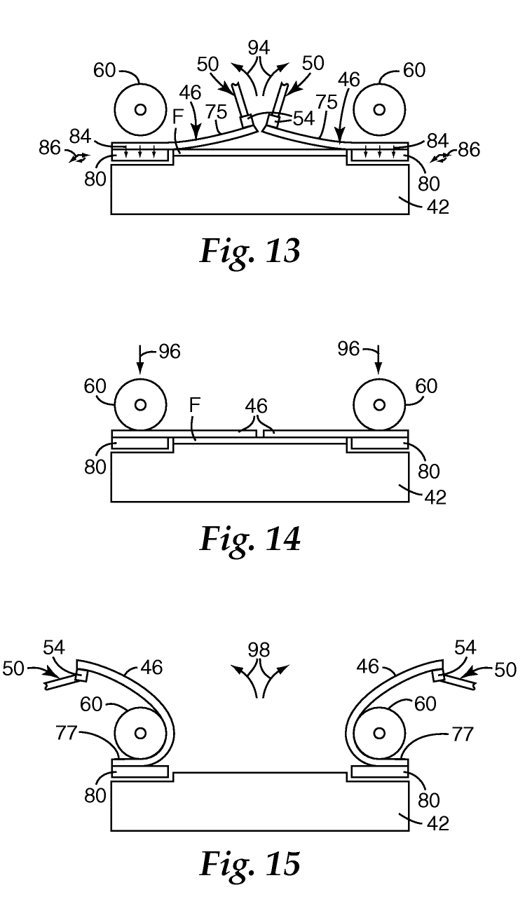

Should adjustment of the position of one or more of the mold sheets 46 be necessary in view of the relative fiducial positions, FIG. 13 illustrates how each mold plate may accordingly be realigned. The vacuum force indicated by arrows 92 is stopped so that each mold sheet 46 is moveable relative to the table 42. Each mold sheet transfer apparatus 50 is re-advanced over the table 42 and engages the free end of its respective mold sheets 46 via the mold sheet engagement bar 54. The free ends of each mold sheet 46 are pulled upwardly, as indicated by arrows 94 in FIG. 13, so that the first portion of each mold sheet 46 is separated from the fiducial plate F. If it has been determined that realignment of a particular mold sheet 46 is desired, the adjustment mount 80 for that mold sheet is moved as necessary to reposition the mold sheet 46 (as indicated schematically by orthogonal arrow sets 86 in FIG. 13). Additionally, one or more of the mold sheets 46 may be realigned as desired independently from one another and simultaneously.

In order to ascertain whether the mold sheets 46 have now been positioned correctly in the molding apparatus, the mold sheets are again flattened and fiducials compared, such as illustrated in FIG. 12 and discussed above, in order to being the fiducials of each mold sheet into a first desired spatial relationship with the baseline fiducials. If further adjustment of a particular mold sheet is necessary, the process of adjustment as illustrated in FIG. 13 and as discussed above is repeated. These comparison and adjustment steps are repeated as necessary until all of the mold sheets are in their precisely desired positions for the molding process.

When each of the mold sheets 46 is in what is believed to be the appropriate position for molding to take place, the vacuum force of arrows 92 is withdrawn and each mold sheet transfer apparatus 50 is withdrawn. Each lamination roller 60 is moved downwardly to engage the second portion of each mold sheet 46 thereunder, so that the second portion of each mold sheet 46 is nipped between the lamination roller 66 and its respective adjustment mount 80. Such movement of the lamination roller 60 is indicated by arrows 96 in FIG. 14. This nipped relationship of the set of mold sheets 46 between their respective adjustment mounts 80 and a single lamination roller 60 is illustrated in FIG. 6, and also via the lowered lamination roller 60 shown in phantom in FIG. 5. At this time, the vacuum force 84 engaging the second portion of each mold sheet 46 to its respective adjustment mount 80 may be dropped.

In order to remove the fiducial plate F from the table 42, each mold sheet transfer apparatus 50 is again advanced over the table 42 and engages the free end of the mold sheets 46 via the mold sheet engagement bar 54. The mold sheet transfer apparatus 50 is then withdrawn over its respective roller 60 and toward the end of the table 42, to again bend the flexible mold sheets 46 back over and away from the table 42, as in the general directions of arrows 98 in FIG. 15. The second portion 77 of each mold sheet 46 remains nipped between the roller 60 and its respective adjustment plate 80, as shown in FIG. 15. Once the mold sheets 46 have been lifted off of the fiducial plate F, the fiducial plate can be removed from the table 42.

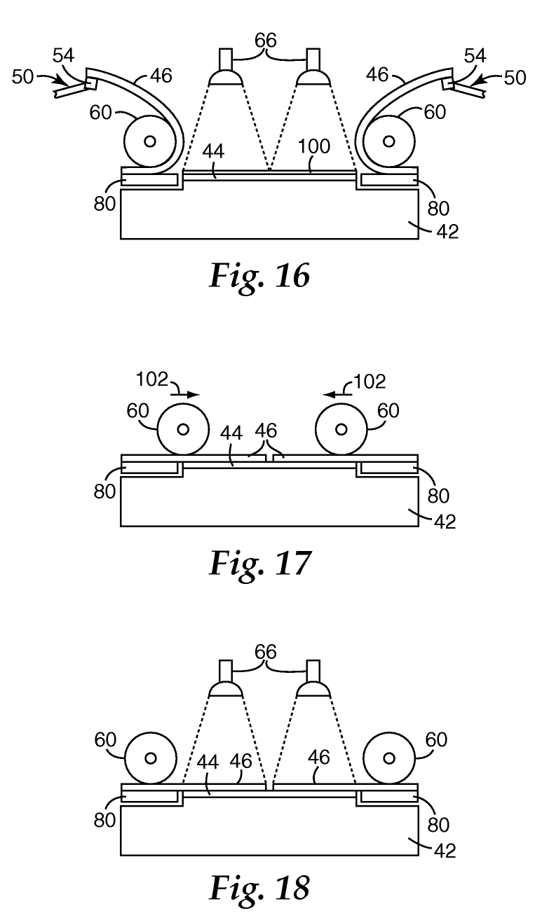

In its place, a substrate 44 is placed onto the table 42, as shown in FIG. 16. A top surface of the substrate 44 is provided with coating material 100, such as cell formation paste, at least within those sections that are to be formed into PDPs. The vision system 66 is used to compare fiducials on the substrate 44 with the already defined baseline fiducials in order to position the substrate 44 for molding. If necessary, the position of the substrate 44 is adjusted using conventional substrate moving techniques and apparatus to align the substrate 44 relative to the table 42 in order to bring their respective fiducials into a second desired spatial relationship. Once the substrate 44 has been appropriately positioned, each mold sheet transfer apparatus 50 is activated to move over the table 42 and allow the mold sheets carried thereby to be disposed over the coating material 100 on the substrate 44. The free ends of the mold sheets 46 are released from engagement with the mold sheet engagement bar 54 and each mold sheet 46 is positioned for molding, with the microstructured surface on the first portion of each mold sheet 46 aligned with the electrodes on the substrate 44. The first portion of each mold sheet 46 is thus positioned over the table 42 and substrate 44 thereon, whereby the fiducials of each mold sheet 46 and the fiducials of the substrate 44 are aligned in a third desired spatial relationship defined as a function of the first and second desired spatial relationships.

As illustrated in FIG. 17, each lamination roller 60 is then advanced across the table 42 to press the first portion of each mold sheet 46 engaged thereby against the coating material 100 on the substrate 44 to form in the coating material a positive image of the mold defined by the microstructured surface of the first portion of that mold sheet 46. Each lamination roller 60 is moved during lamination in direction of arrow 102 as it rolls over the mold sheets 46. The advancements of the lamination rollers 60 are staggered in sequence, so that each lamination roller 60 can advance to a position at or adjacent the free end of its respective mold sheets 46 without interference with the other lamination roller 60. Each lamination roller 60 is then returned to its position of nipped engagement of the second portion of its mold sheet 46 relative to their respective adjustment mounts 80, as seen in FIG. 18 (and in FIG. 5). The vision system 66 may again be activated to measure the position of the mold sheet fiducials relative to the baseline fiducials, as illustrated in FIG. 18.

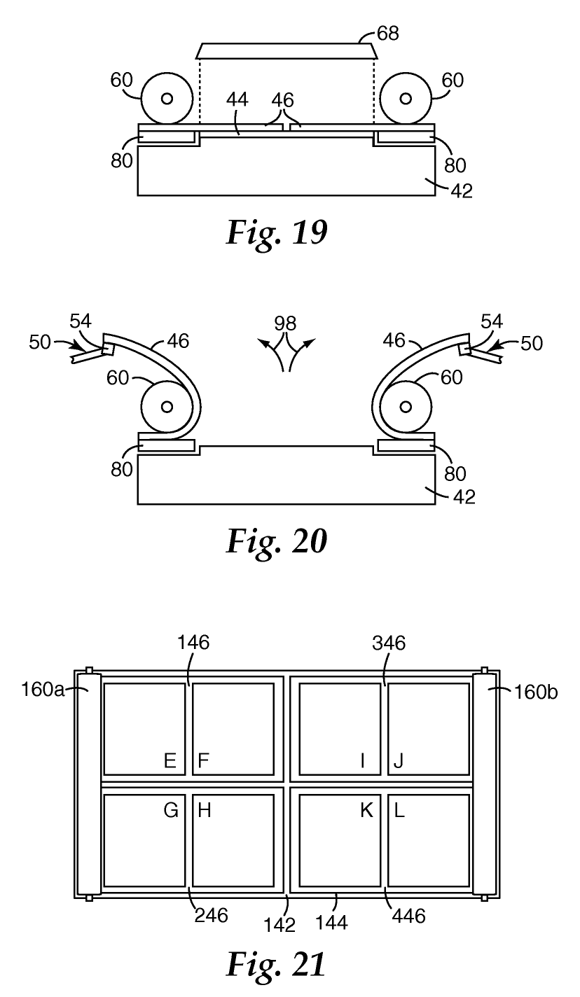

FIG. 19 illustrates the curing step for the coating material which has now been imparted with a specific shape by the molds on the mold sheets 46. The curing system 68 is positioned over the table 42 (is such movement is necessary) and activated to expose the coating material to suitable radiation (through transparent mold sheets 46) to cure the coating material. Once the curing has been completed as necessary, the curing system 68 is deactivated and may be removed from over the table (if necessary). The vision system 66 may again be activated to measure the position of the mold sheet fiducials relative to the baseline fiducials, as illustrated in FIG. 18. Each mold sheet transfer apparatus 50 is advanced over the table 42 to engage the free ends of its respective mold sheets 46 via the mold sheet engagement bar 54. Each mold sheet transfer apparatus 50 is then withdrawn to adjacent an end of the table 42 to delaminate the mold sheet 46 engaged thereby from the coating material on the substrate 44, and to again bend the flexible mold sheets 46 along a controlled path about their respective lamination rollers 60 and away from the table 42 (as indicated generally by arrows 98 in FIG. 20). The vision system 66 may again be activated to measure the position of the cured coating material structure (or fiducials thereof) relative to the baseline fiducials, as illustrated in FIG. 18. The substrate now bearing molded and cured coating material is removed from the table 42. The substrate can then be further inspected and processed as necessary in order to fully produce the desired plasma display panel product. As illustrated in FIG. 20, the lamination apparatus is ready for receiving a next or second substrate covered with coating material and ready for conducting molding operations on that next or second substrate via the mold sheets 46.

The process illustrated in FIGS. 16, 17, 18, 19 and 20 is repeated for subsequent substrates, thus producing a plurality of sections on each substrate which will be ultimately formed into plasma display panels.

It may be advantageous to form as many sections as possible on a single substrate (which may be, for example, of a size such as 2160 mm×2460 mm) as that substrate is processed through the lamination apparatus such as disclosed herein. In the embodiment discussed above, and as specifically illustrated in FIG. 4, four sections A, B, C and D on a substrate are molded by four separate mold sheets 46A, 46B, 46C and 46D. In this way, the four sections of the substrate are then prepared for use in making four discrete plasma display panels. In order to make additional sections of the substrate ready for plasma display panel production, it is possible to provide, on each mold sheet, a plurality of molds so that each mold sheet may prepare a plurality of sections of a single substrate. An example of such an arrangement is illustrated in FIG. 21. Here a substrate 144 is provided with coating material on at least eight sections thereof, sections E, F, G, H, I, J, K and L. In this embodiment, four mold sheets are again provided, as indicated by mold sheets 146, 246, 346 and 446. The mold sheets 146 and 246 define a first set of mold sheets which are engaged and laminated by a first lamination roller 160a. Mold sheets 346 and 446 define a second set of mold sheets which are engaged and laminated by a second lamination roller 160b. As seen in FIG. 21, the lamination rollers 160a and 160b are disposed at the opposed ends of a table 142, disposed over the substrate 144, in the same general manner as illustrated in the embodiment of FIG. 4.

Mold sheet 146 has a first portion that extends over the table 142 (and substrate 144) that has two microstructured surface sections thereon, each defining a mold comprising, at least in part, a reverse image of a set of cells thereon. Disposed over the substrate 144, the molds on the mold sheet 146 correspond generally in position to the sections E and F of the substrate 144 (wherein each of those sections have been provided with coating material over an electrode arrangement, with the coating material to be engaged and formed by the molds on the mold sheet 146). In this way, the mold sheet 146 thus bears two molds and forms two sections of the substrate that may form two discreet plasma display panel portions. Each of the other mold sheets 246, 346 and 446 is likewise formed to have multiple molds for corresponding to the respective sections of the substrate 144 disposed thereunder, as illustrated in FIG. 21. As may be appreciated, other configurations are likewise possible to achieve molding efficiencies. For example, a single substrate may have six sections thereon which can be molded by molds born on three separate mold sheets, each bearing two molds and pressed against a substrate by a single lamination roller.

The processing of each substrate through the molding apparatus represents one cycle. During processing, the individual mold sheet alignment relative to the table, as illustrated in FIG. 13 and discussed above, may be continually adjusted to reposition the mold sheet based on real time feedback of errors in the average position of the true features of the components (i.e., by comparing fiducial positions therebetween). Such errors could be due to swelling of the mold sheets, thermal distortions, physical distortions, or any slow changing or constant errors in the overall molding apparatus processing system. Such errors in the discrete measurements that are detected by vision system 66 can be filtered out with a digital feedback loop. (such as X(t)=K₁xY(t−1)+K₂xY(t−2)+K₃xY(t−3), where Kᵢ are gain values, Y is the measurement (error), X is the change, and t is the current cycle, t−1 is the previous cycle, etc.). Additionally, errors in the position of the electrodes relative to the substrate fiducials on each incoming substrate 44 can be compensated for if they were measured before loading or using the position data generated during the process illustrated in FIG. 16.

The use of a separate adjustment mount 80 for each mold sheet 86 provides enhanced flexibility for the molding assembly in terms of mold sheet alignment relative to the substrate. It is contemplated that individual mold sheets may not need to be realigned between subsequent uses during molding of the substrate in a series (i.e., for a number of cycles of the molding apparatus). In other words, once the process of mold sheet alignment relative to the baseline fiducials has been achieved using that mold sheet adjustment mount, the lamination roller can be used over and over again without the need to realign individual mold sheets relative to the table and that lamination roller. The lamination roller never releases any of the mold sheets of its respective set of mold sheets, since it always rests on the tail (the second portion) of each mold sheet of its set, on its respective adjustment mount. Thus, it is possible to reuse mold sheets in a relatively rapid fashion (without taking the time to constantly realign the mold sheets relative to each new substrate), which will serve to make the molding process more efficient and provide cost advantages. The molding process disclosed herein provides these advantages without significant increase in the cost and complexity of lamination equipment.

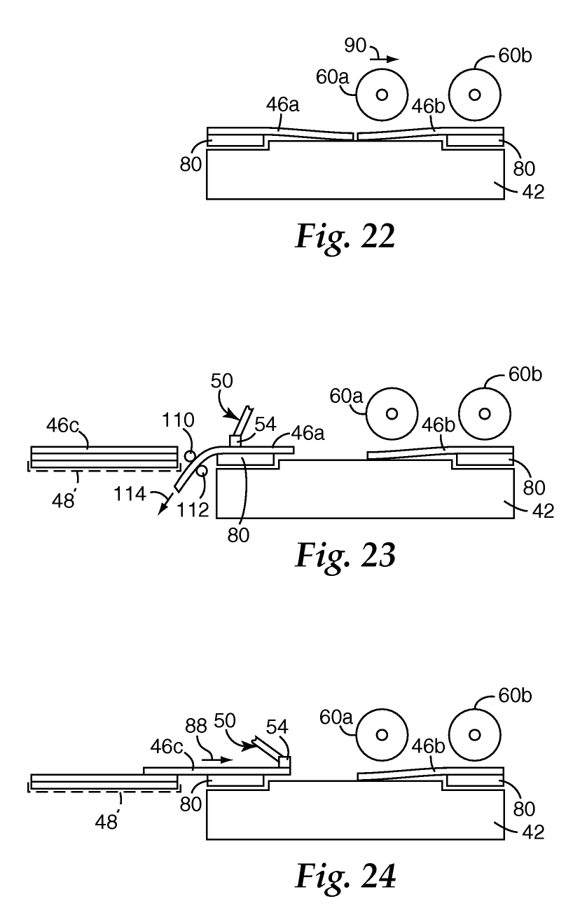

If it is discovered that one of the mold sheets has a defect, has worn out or carries some coating material or other debris, that mold sheet may be replaced without replacing the other mold sheets that are in position and still correctly aligned for molding. The process for replacing a single mold sheet is illustrated in FIGS. 22-24.

Mold sheet 46a is being replaced, while mold sheet 46b is not. Accordingly, roller 60b for mold sheet 46b remains in its nipped engagement relationship with respect to the adjustment mount 80 for the mold sheet 46b, thereby holding the mold sheet 46b precisely in place as previously aligned. If the adjustment mount 80 also is using vacuum force to hold the mold sheet 46b in place down, that vacuum force also remains activated.

With respect to mold sheet 46a, however, its respective lamination roller 60a has been moved upwardly and out of nipped engagement relative to the adjustment mount 80 for the mold sheet 46a. The lamination roller 60a is then moved over the table in direction illustrated by arrow 90 (see FIG. 22) so as not to interfere with the removal of the mold sheet 46a from the table by its mold sheet transfer apparatus 50 (which may be selectively activated to only engage one mold sheet of the respective set of mold sheets for a lamination roller). This removal is illustrated in FIG. 23, wherein the mold sheet transfer apparatus 50 has engaged the mold sheet 46a to be replaced via its mold sheet engagement bar 54 and moved the mold sheet 46a off the end of the table 42 and into a mold sheet disposal apparatus which may include a pair of opposed rollers 110 and 112 which are positioned to engage the mold sheets 46a therebetween and rotated to advance the mold sheet 46a into a disposal area, with such mold sheet movement illustrated by arrow 114.

Once the mold sheet 46a has been engaged by the mold sheet disposal apparatus, it is disengaged by the mold sheet engagement bar 54. After the mold sheet 46a has been completely removed from over the table 42, the mold sheet engagement apparatus 50 engages a next mold sheet (such as mold sheet 46c) in the mold sheet staging area 48 and advances the mold sheet 46c onto the table 42, as illustrated generally by arrow 88 in FIG. 24. As illustrated in FIGS. 23 and 24, during the removal and replacement process of the mold sheets, lamination roller 60a remains positioned out of the way, such as disposed over the mold sheet 46b. Once the mold sheet 46c has been fully advanced into position over the table 42 (so that its first portion is disposed over the table and its second portion is disposed over its respective adjustment mount 80), the mold sheet engagement bar 54 is again released from the mold sheet 46c and the mold sheet transfer apparatus 50 moves out of its position over the table 42. The lamination roller 60a is then moved back to its original position over the adjustment bar 80 for the mold sheet 46c (in direction opposite of arrow 90 in FIG. 22). The second portion of the new mold sheet 46c is then coupled to its respective adjustment mount 80 (such as by vacuum forces 84) and the necessary steps to put the new mold sheet 46c into a proper position for molding are taken (such as illustrated and discussed above with respect to FIGS. 12, 13 and 14). Since each mold sheet has a separate adjustment mount, it is thus possible to replace a single mold sheet and realign it without affecting the alignment of the other mold sheets already in place in the molding apparatus. Once the replaced mold sheet has been placed in a desired position, relative to the baseline fiducials, molding can then be recommenced with respect to a next substrate, in the manner described above.

Various other aspects that may be utilized in connection with the subject matter disclosed herein are known in the art, including, but not limited to each of the following patent publications that are incorporated herein by reference: U.S. Patent Publication No. 2006/0043634, U.S. Patent Publication No. 2006/0043638, U.S. Patent Publication No. 2006/0231728, U.S. Patent Publication No. 2006/0043647, U.S. Patent Publication No. 2007/0018363, U.S. Patent Publication No. 2007/0071948, U.S. Patent Publication No. 2007/0018348, U.S. Patent Publication No. 2006/0235107 and PCT No. WO 01/52299.

Although the apparatus and methods disclosed herein have been described with respect to several embodiments, workers skilled in the art will recognize that changes may be made in form and detail without departing from the spirit and scope of the apparatus and methods of this disclosure. For instance, while this disclosure has discussed PDPs, it will be recognized that other devices and articles can be formed using the disclosed methods including, for example, electrophoresis plates with capillary channels and lighting applications. In particular, devices and articles that can utilize molded ceramic microstructures can be formed using the methods described herein. While this disclosure is not so limited, an appreciation of various aspects of the disclosure will be gained through a discussion of the examples provided above.

What is claimed is:

1. A method for forming a plurality of discrete sets of cells on a substrate used for forming plasma display panels, the method comprising:
locating baseline fiducials relative to a substrate support surface;
disposing a first portion of each of a plurality of flexible mold sheets over the substrate support surface, wherein the first portion of each mold sheet has a microstructured surface facing the substrate support surface that defines a mold comprising, at least in part, a reverse image of a set of cells thereon, and wherein the first portion of each mold sheet has fiducials thereon;
comparing the relative positions of fiducials on each mold sheet with the baseline fiducials; and
securing a second portion of each mold sheet to an adjustment mount relative to the substrate support surface to bring the fiducials of each mold sheet into a first desired spatial relationship with the baseline fiducials, thereby adjusting the position of the first portion of each mold sheet independently relative to the substrate support surface.

2. The method of claim 1, and further comprising:
removing the first portion of each mold sheet from its position overlying the substrate support surface;
coating a surface of a substrate with cell formation paste;
placing the substrate on the substrate support surface;
comparing the relative positions of fiducials on the substrate with the baseline fiducials;
aligning the substrate relative to the substrate support surface to bring their respective fiducials into a second desired spatial relationship; and
repositioning the first portion of each mold sheet over the substrate support surface and substrate thereon, whereby the fiducials of each mold sheet and the fiducials of the substrate are aligned in a third desired spatial relationship defined as a function of the first and second desired spatial relationships.

3. The method of claim 2, and further comprising:
pressing the first portions of the mold sheets against the substrate to form in the paste on the substrate, for each mold sheet, a positive image of the mold defined by the microstructured surface of the first portion of that mold sheet.

4. The method of claim 3 wherein the pressing step comprises:
urging the first portion of each mold sheet toward the substrate with a laminating roller.

5. The method of claim 2 wherein the repositioning step comprises:
aligning the mold on each mold sheet with a set of electrodes disposed on the substrate.

6. The method of claim 3 wherein a first set of the plurality of mold sheets are disposed side-by-side with their respective first portions over the surface of the substrate, and wherein the pressing step comprises:
urging the first portion of each mold sheet of the first set toward the substrate with a first laminating roller.

7. The method of claim 6 wherein a second set of the plurality of mold sheets are disposed side-by-side with their respective first portions over the surface of the substrate, opposed to the first set, and wherein the pressing step comprises:
urging the first portion of each mold sheet of the second set toward the substrate with a second laminating roller.

8. The method of claim 3 and further comprising:
curing the paste; and
separating each mold sheet from the paste.

9. The method of claim 3 wherein each mold sheet is pressed against the substrate simultaneously.

10. The method of claim 1 wherein, on the first portion of each mold sheet, the microstructured surface defines a plurality of said molds.

11. The method of claim 1 wherein the position of the first portion of each mold sheet is adjusted relative to the substrate support surface at the same time.

12. The method of claim 1 wherein, once the fiducials are in the first desired spatial relationship, the method further comprises:
moving a laminating roller toward the adjustment mount to hold the second portion of each mold sheet therebetween.

13. The method of claim 1 wherein the locating step comprises:
sensing fiducials formed on the substrate support surface;
disposing a calibration plate on the substrate support surface, wherein the calibration plate has fiducials thereon; and
comparing relative positions of fiducials on the calibration plate with the fiducials on the substrate support surface in order to define the baseline fiducials as the fiducials on the calibration plate, wherein the calibration plate remains on the substrate support surface until the first spatial relationship is defined.

14. The method of claim 14, and further comprising:
removing the calibration plate from the substrate support surface.

15. A method for forming a plurality of discrete sets of cells on substrates used for forming plasma display panels, the method comprising:
advancing a first substrate of a plurality of substrates onto a table, wherein at least a portion of an exposed surface of each substrate is coated with cell formation paste;
disposing a plurality of side-by-side flexible mold sheets over the paste on the surface of each substrate when that substrate is on the table, wherein each mold sheet has a microstructured surface facing the paste on the surface of said substrate that defines a mold comprising, at least in part, a reverse image of a set of cells thereon;
adjusting the position of each mold sheet independently relative to the first substrate;
fixing the position of each mold sheet independently relative to the first substrate;
pressing the mold sheets against the first substrate to form in the paste on the first substrate, for each mold sheet, a positive image of the mold defined by the microstructured surface of that mold sheet;
disengaging each mold sheet from the first substrate;
replacing the first substrate on the table with a second substrate advanced onto the table, wherein at least a portion of an exposed surface of the second substrate is coated with cell formation paste;
optionally adjusting the position of each mold sheet independently relative to the second substrate;
fixing the position of each mold sheet independently relative to the second substrate; and
pressing the mold sheets against the second substrate to form in the paste on the second substrate, for each mold sheet, a positive image of the mold defined by the microstructured surface of that mold sheet.

16. The method of claim 15 wherein the pressing steps comprise:
urging each mold sheet toward the table with a lamination roller.

17. The method of claim 15 wherein each adjusting step comprises:
aligning the mold on each mold sheet with a set of electrodes disposed on the substrate that is on the table.

18. The method of claim 15 wherein, after the disengaging step, the method further comprises:
replacing one of the mold sheets of the plurality of flexible mold sheets with a substitute flexible mold sheet, wherein the substitute mold sheet has a microstructured surface that defines a mold comprising, at least in part, a reverse image of a set of cells thereon.

19. The method of claim 15, wherein the optionally adjusting step comprises:
sensing that a mold sheet is out of a desired alignment with the second substrate.

20. The method of claim 19 wherein the sensing step further comprises:
filtering noise from one or more sensed conditions using a digital feedback loop.
